(19) United States
(12) Patent Application Publication
(10) Pub. No.: US 2004/0047476 A1
(43) Pub. Date: Mar. 11, 2004

(54) Method and system for improved sound quality of automotive audio

(76) Inventor: Shinichi Sato, Plymouth, MI (US)

Correspondence Address: DVA/PIONEER INDUSTRIAL COMPONENTS, INC., 2355 MAIN STREET, SUITE 200, IRVINE, CA, 92614, US

(21) Appl. No.: 10/064,977

(22) Filed: Sep. 5, 2002

(51) Int. Cl. H04B 1/00; H04R 1/02

(52) U.S. Cl. 381/89; 381/86

(57) ABSTRACT

An automobile audio system having reflected sound distribution in which a linearly spatial sound image can be created giving the listener sound from the left, right, and center using preferably mid-to-high frequency range speakers. This linearly spatial sound image is created by placing a pair of mid-to-high frequency range speakers in a generally center section of the upper dashboard surface in an automobile and directing the sound emitted by the speakers towards the forward respective interior corners of the automobile wherein the left speaker is directed towards the left corner and the right speaker is directed towards the right corner. In this manner, the sound from the mid-to-high frequency range speaker is axially directed away from the occupants and reflected back to the occupants using the interior surfaces of the automobile.

### BACKGROUND OF INVENTION

Field of the Invention

This invention relates generally to automotive entertainment systems, and more specifically, to a system and method for enhancing the sound quality of automotive entertainment systems.

Automobile audio systems face unique issues in reproducing recorded and broadcast sound. Traditional speaker placement, speaker types, limited internal and other factors can all affect the quality of the sound that reach the occupants of the automobile. Moreover, the interior designs of automobile dashboards are asymmetrical, that not only limits speaker locations for optimum sound but also causes a lack of spatial linearity in the reproduced sound.

Traditional placement and orientation of mid-to-high frequency range speakers or full-range speakers has been to place the speakers in a manner that emits the sound directly towards the occupant. These speakers are typically placed near the forward corners of the dashboard closest to the windshield, on the kickpanels of the door, the A-pillars, or near the sideview mirror setting position, with the speakers axially directed towards the closest front passenger position.

Such traditional placement and orientation of speakers in an automobile audio system has many drawbacks. First, only the closest speaker is able to bring clear sound to the listener. Second, this traditional placement and orientation makes it very difficult to create a sound image in the center section of the dashboard because the primary sound is emanating from either the right or left of the listener. Some systems place the speakers in the head unit or have a center speaker on the dashboard directed towards the occupants, but this cannot only be cost prohibitive, but also still lack spatial linearity.

Still another disadvantage found in traditional automobile audio systems and methods of speaker placement in these systems is the inability of the system to reproduce studio quality sound. The closest speaker to the occupant dominates the sound image available to that occupant thereby distorting the stereophonic sound reproduction. In home theater systems and studio sound systems, speakers are placed in a manner to create a sound image that surrounds the listener and allows the listener to hear sound from the front channel, rear channels, or side channels. In home theater systems and studio systems, sound images can emanate from the right, left, and center of the listener as well as from the rear. Due to the internal geometry of an automobile, current automobile audio systems are unable to faithfully reproduce studio sound. In addition, traditional speaker placement in automobiles do not allow for the reproduction of studio sound because there is a lack of a center speaker to produce these sounds. Traditional automobile audio systems without center speakers cannot accurately reproduce these studio sound images because they do not have speaker placement that creates a complete sound image to the left, right, and center of the listener. Since speakers are not traditionally placed in the center of the dashboard, a center sound image cannot be produced.

As previously mentioned, some car audio systems have attempted to resolve the lack of sound from a center channel by placing speakers in the head unit or near the center rearview mirror. However, placing a speaker in the head unit or near the center rearview mirror is not an effective way to reproduce studio sound because the center speakers are not the same distance away from the listener as the side speakers near the sideview mirror controls or the surround positions. The variation in distances of the speakers to the listeners creates distortion in the sound image due to differences in time it takes for the sound image to reach the listeners. Also, the placement of additional speakers in the head unit or near the center rearview mirror is more expensive due to the costs of adding additional speakers.

Accordingly, there is a need for improving the sound quality of an automobile's sound system that optimizes the existing designs of the vehicle's interior design. The present invention satisfies this need, as well as others, and generally overcomes the deficiencies of typical automotive sound systems.

### SUMMARY OF INVENTION

In accordance with the present invention, an automobile audio system having directed sound distribution in which a sound image can be created giving the listener mid-to-high frequency sound from the left, right, and center, is provided. Mid-to-high range speakers may include speakers known as “tweeters” to those skilled in the art and have a typical frequency of approximately 3 kHz to 22 kHz. The speaker placement in the current invention is intended to recreate studio sound by providing a more linear spatial response to the listener.

This more linearly spatial sound image is generated by placing speakers in a generally center region of the dashboard and orienting the sound from the drivers axially directed towards the front interior left and right corners of the automobile. Even though the sound waves from the speaker are axially directed away from the occupants, they are reflected back to the occupants by the windshield and interior structure of the automobile. This unique configuration allows the occupants in the front of the automobile to receive a more spatially complete sound image from the right, left, and center.

It is commonly known that the velocity of the sound wave is a factor in the ability of sound waves to be reflected. Thus, this technique is best utilized by mid-to-high frequency speakers. By having the sound image originate in the center and then reflected back towards the occupants, the occupants in the automobile are provided with a more linearly spatial sound because the sound axis of any one speaker is not aimed directly at the occupant. Since the reproduced sound becomes more linearly spatial to the listener, the present invention recreates a more faithful studio sound.

The sound from the speakers may be further improved by placing acoustic reflectors in the front interior portion of the automobile adjacent the corners of the windshield. These acoustic reflectors may be designed to provide a more accurately directed sound reflection to the occupants that will further improve the sound quality. In addition, the acoustic reflectors may be designed to aesthetically match the interior design of the automobile and perhaps to even further enhance its appearance. This will visually satisfy the listener as well as the automobile manufacturer. In addition, to further maintain an aesthetically pleasing appearance, the speakers may be recessed in the center region of the dashboard in order to create a flush, fully integrated look. Moreover, this will alleviate any visual obstructions to the driver and passenger of the road.

Accordingly, it can be seen that the method and system in accordance with the present invention can provide a faithful reproduction of studio sound by providing the occupants of an automobile with not only a more spatially complete sound image from the speakers that may be readily implemented in all production automobiles, but also adaptable to existing automobiles.

It is an object of this invention to provide a system and method for improved sound quality in an automobile audio system.

It is another object of this invention to provide a system and method for more accurately reproducing sound that provides a more linear spatial response to the occupants in an automobile.

It is a further object of this invention to provide a system and method for improved sound quality in an automobile audio system by utilizing sound reflectors in conjunction with specific speaker placement.

It is still a further object of this invention to provide a system and method for improved sound quality in an automobile that is not only fully integrated into the automobile's interior design, but also provides an aesthetically pleasing appearance.

### BRIEF DESCRIPTION OF DRAWINGS

FIG. 1 is a plan view of a conventional two-speaker layout in an automobile audio system.

FIG. 2 is a plan view of a studio sound image relative to an ideal listening position.

FIG. 3 is a plan view of a conventional four-speaker layout in an automobile audio system.

FIG. 4 is a plan view of a speaker system of the present invention.

FIG. 5 is an elevational view of a preferred embodiment of the present invention shown in FIG. 3.

FIG. 6 is a plan view of an alternate embodiment of the present invention shown in FIG. 3.

### DETAILED DESCRIPTION

A system and method for improved sound quality in automobiles will be described with reference to accompanying figures. Numerous details are set forth in order to provide a thorough understanding of the present invention. However, it will be appreciated that the system and method may vary as to the configuration and as to the details without departing from the basic concepts herein disclosed.

Referring first to FIG. 1, a conventional layout for two speakers, such as mid-to-high range speakers or tweeters 10 and 12, in an automobile interior compartment 14 is generally shown. Within automobile interior compartment 14 is a passenger area 16 and a dashboard 18 that is disposed in front of passenger area 16. Left and right occupants, 20 and 22 respectively, are generally positioned within passenger area 16 behind dashboard 18. In such conventional layouts, speakers 10 and 12 are positioned in the outer edges of dashboard 18 adjacent the A-pillars of the vehicle (not shown) located on the left side 24 and right side 26 of dashboard 18. Speaker 10 is positioned so that the sound 28 emanating therefrom is generally directed towards its closest occupant, which is left occupant 20. Similarly, speaker 12 is positioned so the sound 30 emanating therefrom is generally directed towards its closest occupant, which in this instance is right occupant 22. Speaker 10 is configured to reproduce a signal for a left channel in a stereo amplifier while speaker 12 is configured to reproduce a signal for a right channel in the amplifier.

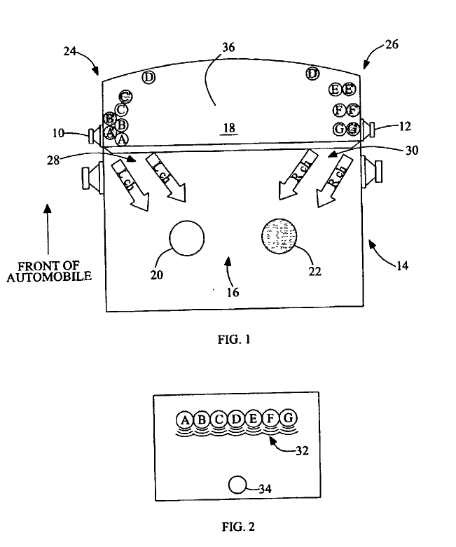

Referring also to FIG. 2, a representation of an ideal studio sound image 32 is generally shown in relation to an ideal listening position 34. Sound image 32 may be divided into generally seven sound regions as depicted in circles A, B, C, D, E, F, and G. Sound image 32 represented by circles A-G are arranged in spatially linear fashion from left to right that is heard in an ideal studio environment of even a live performance. In the spatially linear sound image as shown, sound is heard by listener 34 with a full stereophonic effect.

Referring again to FIG. 1, it may be seen that with conventional speaker layouts, sound regions A, B, C, and D emanate from the left side 24 of dashboard 18 where speaker 10 is located, while sound regions E, F, and G emanate from the right side 26 of dashboard 18. Hence, left occupant 20 perceive the sound image depicted by sound regions A, B, C, D, biased from the left side 24 of dashboard 18. By symmetry, the right occupant perceives sound regions D′, E′, F′, and G′ which emanate from the right side 26 of dashboard 18 where speaker 12 is located while sound regions A′, B′, and C′ emanate from the left side 24 of dashboard 18. As such, a “hollow effect” occurs around the center section 36 of dashboard 18 wherein the sound image is not spatially linear. The disadvantage that results is a lack of full stereophonic effect.

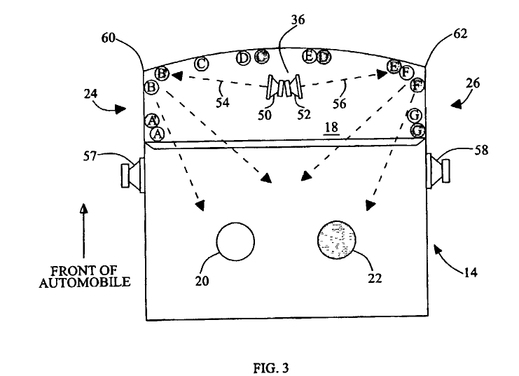

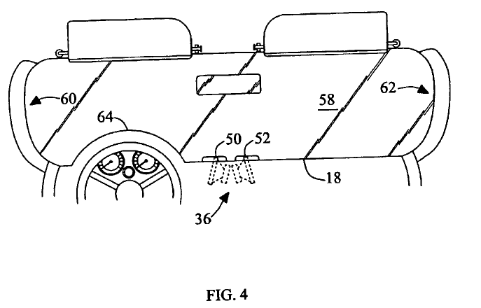

Referring now to FIG. 3, the speaker system of the present invention is generally shown. A pair of speakers 50 and 52, or otherwise mid-to-high frequency range speakers or tweeters, are located generally in central section 36 of dashboard 18. Speakers 50 and 52 reproduce the left and right stereo channels, respectively, and may be proximate to each other but oriented such that the sound emanating therefrom are directed towards opposite ends of dashboard 18 of the automobile. Speaker 50 is directed towards the left corner of interior compartment 14 formed by the A-pillar and windshield 59 that is adjacent the left side 24 of dashboard 18, and speaker 52 is directed towards right corner of interior compartment 14 formed by the opposing A-pillar and windshield 59 that is adjacent the right side 26 of dashboard 18. Speaker 50 generates sound waves 54 that reflect off the curvature of the windshield 59 towards occupants 20 and 22, while speaker 52 generates sound waves 56 that reflect off the curvature of the windshield towards occupants 20 and 22. The sound reflected from sound wave 54 is generally represented by circles A, B, C, and D as perceived by occupants 20 and 22, while the sound reflected by sound wave 56 is represented by circles D, E, F, and G as perceived by occupants 20 and 22. The effect of both reflected sound waves is to create a more linearly spatial response in front of occupants 20 and 22 thereby reproducing a full stereophonic sound. The specific orientation of speakers 50 and 52 is such that the angle, (theta), is 0 degrees or greater.

The present invention allows for studio quality sound to be reproduced accurately and cost effectively with the use of only two speakers 50 and 52, as the placement of the speakers in the general center section 36 of dashboard 18 utilizes the interior structure of the automobile to help direct sound to the central area of interior compartment 14. This creates a sound image perceived as coming from center section 18 as shown by circles C, D, and E, and C′, D′, and E′ thereby eliminating the “hollow effect”. Moreover, since the sound waves emanating from speakers 50 and 52 do not directly collide, there would be no perceived sound distortion created by such an interference.

The present invention may incorporate additional full range speakers or low-to-mid range speakers 57 and 58 to help provide a spatially linear sound image to occupants 20 and 22. Full range speakers typically have a frequency range between approximately 20 Hz and 22 kHz. Low-to-mid range speakers typically have a frequency range of approximately 20 Hz to 4 kHz. Such speakers may be placed along the sides of interior compartment 14, such as in the door panels. These full range speakers provide the lower frequency sounds that tweeters generally do not reproduce. In addition, full range speakers can reproduce studio-quality sound image from locations represented by circles A and G. The balance between speakers 50 and 52 and speakers 57 and 58 can be finely tuned to achieve an optimum sound image.

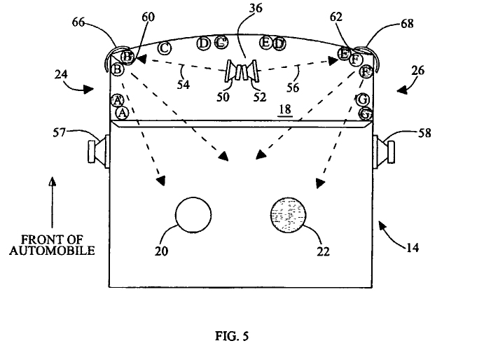

Referring also to FIG. 4, in a preferred embodiment of the present invention shown in FIG. 3, speakers 50 and 52 are placed in the center section 36 of the dashboard 18 near the windshield 59. Speakers 50 and 52 are axially directed towards the internal frontal corners 60 and 62, respectively, of interior compartment 14. Placing speakers 50 and 52 closer to windshield 58 allows the sound emanating therefrom to avoid any obstructions on the dashboard, such as the instrument panel pod 64 found on the majority of automobiles, while allowing the sound to travel approximately the same distance to each frontal corner 60 and 62. Other obstructions may include the curvature of the dashboard, air bags, glove compartment doors, air vents, and the like. Use of this location also simplifies the design and assembly of speakers into dashboards of automobiles employing right-hand drive configurations.

As further shown in FIG. 4, speakers 50 and 52 may also be either relatively flush with the surface of dashboard 18 or even recessed therein. They can also be protected by speaker guards that allow for sound to pass through while protecting the speaker. This makes the invention more aesthetically appealing, as the speakers will be invisible to occupants 20 and 22 of the automobile. Reducing the profile of the speakers also serves to prevent obstructing the driver's view of the road.

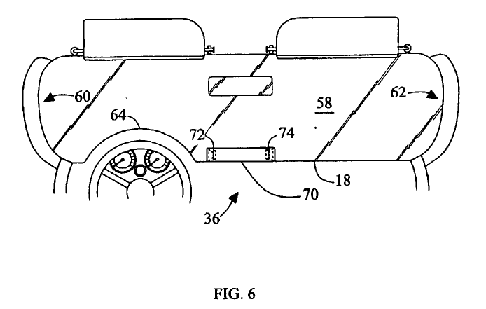

Referring to FIG. 5, acoustic reflectors 66 and 68 may be coupled to frontal corners 60 and 62, respectively. The adjustability of acoustic reflectors 66 and 68 provide improved sound to occupants 20 and 22 by accurately directing reflected sound thereto. Incorporating specifically designed acoustic reflectors 66 and 68 provides better control over the sound image perceived by occupants 20 and 22. Acoustic reflectors 66 and 68 may also be designed to aesthetically match the interior compartment 14 of the automobile. This feature can be used in marketing the present invention as a further enhancement package that provides improved sound quality.

Referring to FIG. 6, the present invention may be adapted for an after-market embodiment for automobiles not equipped with the present invention at the time of manufacture. In this embodiment, a housing 70 encloses two opposing speakers 72 and 74 which are axially directed at angle (theta) shown in FIG. 3 towards the A-pillar and windshield 59. The housing may, however, contain more than two speakers. This after-market assembly may be coupled to the center region 36 of the dashboard 18 so that an existing audio system in a vehicle manufactured without the present invention may enjoy the benefits of the present invention.

The housing 70 may be designed to be of a low profile in order to avoid obstructing the view of the occupants 20 and 22 of the vehicle. In addition, the after-market embodiment of the present invention may also be sold with after-market acoustic reflectors that may be coupled to the A-pillar to maximize the benefits of the present invention. In addition, the housings as well as the acoustic reflectors may be specifically designed for different makes and models of automobiles in order to maximize the effectiveness as well as the aesthetic value of the present invention.

In the foregoing specification, the present invention has been adequately described to disclose preferred embodiments. It is to be understood that the invention is not limited to the specific features described. The modifications may be made to the present invention without departing from the spirit and scope of the invention as defined by the following claims.

1. An improved speaker system for an automobile having a dashboard and a windshield, comprising:
(a) a first speaker and a second speaker;
(b) wherein said first speaker and said second speaker are disposed generally on a center section of an upper surface of the dashboard;
(c) wherein said first speaker is oriented so that sound waves emanating therefrom are directed towards a left edge of the dashboard adjacent the windshield; and
(d) wherein said second speaker is oriented so that sound waves emanating therefrom are directed towards a right edge of the dashboard adjacent the windshield.

2. The system recited in claim 1, wherein said first speaker and said second speaker comprises mid-to-high frequency range speakers.

3. The system recited in claim 1, wherein said first speaker and said second speaker comprises tweeters.

4. The system recited in claim 1, wherein said first speaker and said second speaker are juxtaposed.

5. The system recited in claim 1, wherein said first speaker and said second speaker are flush with the upper surface of the dashboard.

6. The system recited in claim 1, wherein said first speaker and said second speaker are in close proximity to the windshield.

7. The system recited in claim 1, further comprising a first acoustic reflector and a second acoustic reflector, said first acoustic reflector positioned to the sound waves emanating from said first speaker, and said second acoustic reflector positioned to receive the sound waves emanating from said second speaker.

8. The system recited in claim 7, wherein said first acoustic reflector and said second acoustic reflector are adjustable.

9. A method of improving sound quality of an automotive sound system in an automobile having a dashboard and a windshield, comprising:
(a) installing a first speaker and a second speaker generally on a center section of an upper surface of the dashboard;
(b) orienting said first speaker so that sound waves emanating therefrom are directed towards a left edge of the dashboard adjacent the windshield; and
(c) orienting said second speaker so that sound waves emanating therefrom are directed towards a right edge of the dashboard adjacent the windshield.

10. The method recited in claim 9, further comprising:
(a) positioning a first acoustic reflector to receive the sound waves emanating from said first speaker; and
(b) positioning a second acoustic reflector to receive the sound waves emanating from said second speaker.

11. The method recited in claim 9, wherein said first acoustic reflector and said second acoustic reflector are adjustable.

12. The method recited in claim 9, further comprising juxtaposing said first speaker and said second speaker.

13. The method recited in claim 9, wherein installing said first speaker and said second speaker further comprises placing said first speaker and said second speaker in close proximity to the windshield.

14. The method recited in claim 9, wherein said first speaker and said second speaker comprises mid-to-high frequency range speakers.

15. The method recited in claim 9, wherein said first speaker and said second speaker comprises tweeters.

16. The method recited in claim 9, wherein installing said first speaker and said second speaker comprises placing said first speaker and said second speaker flush with the upper surface of the dashboard.

17. A method of improving sound quality of an automotive sound system in an automobile having a dashboard, a windshield, and at least a pair of speakers, comprising:
(a) reflecting the sound waves emitted by said first speaker off a left side of the windshield;
(b) reflecting the sound waves emitted by said second speaker off a right side of the windshield;
(c) directing the sound waves reflected by said first speaker towards a passenger compartment; and
(d) directing the sound waves reflected by said second speaker towards the passenger compartment.

18. The method of claim 17, further comprising:
(a) positioning a first acoustic reflector to receive the sound waves emanating from said first speaker; and
(b) positioning a second acoustic reflector to receive the sound waves emanating from said second speaker.

19. The method recited in claim 18, wherein said first acoustic reflector and said second acoustic reflector are adjustable.

20. The method recited in claim 17, further comprising juxtaposing said first speaker and said second speaker.

21. The method recited in claim 17, wherein installing said first speaker and said second speaker further comprises placing said first speaker and said second speaker in close proximity to the windshield.

22. The method recited in claim 17, wherein said first speaker and said second speaker comprises mid-to-high frequency range speakers.

23. The method recited in claim 17, wherein said first speaker and said second speaker comprises tweeters.

24. The method recited in claim 17, wherein installing said first speaker and said second speaker comprises placing said first speaker and said second speaker flush with the upper surface of the dashboard.

25. A speaker system for an automobile having a dashboard and a windshield, comprising:
(a) a housing;
(b) a first speaker and a second speaker;
(c) wherein said first speaker and said second speaker are opposingly disposed within said housing;
(d) wherein said housing may be coupled to an upper surface of a general central region of said dashboard; whereby sound waves emanating from said first speaker is directed towards a left edge of the windshield and dashboard and whereby sound waves emanating from said second speaker is directed towards a right edge of the windshield and dashboard.

26. The system of claim 25, wherein said first speaker and said second speaker are tweeters.

27. The system recited in claim 25 wherein said first speaker and said second speaker are in close proximity to the windshield.
